(19) United States
(12) Patent Application Publication
(10) Pub. No.: US 2009/0276600 A1
(43) Pub. Date: Nov. 5, 2009

(54) METHOD AND APPARATUS FOR DETERMINING MEMORY USAGE FOR A COMPUTING DEVICE

(75) Inventor: David Wallman, San Mateo, CA (US)

Correspondence Address: PVF -- ORACLE INTERNATIONAL CORPORATION;c/o PARK, VAUGHAN & FLEMING LLP, 2820 FIFTH STREET, DAVIS, CA, 95618-7759, US

(73) Assignee: ORACLE INTERNATIONAL CORPORATION, Redwood Shores, CA (US)

(21) Appl. No.: 12/115,334

(22) Filed: May 5, 2008

(51) Int. Cl. G06F 12/00

(52) U.S. Cl. 711/170; 711/E12.001

(57) ABSTRACT

One embodiment of the present invention provides a system that determines memory usage for a computing device. Within the computing device, an operating system manages memory allocation, and speculatively allocates otherwise-unused memory in an attempt to improve performance. During operation, the system receives a request to estimate the memory usage for the computing device. In response, the system determines an active subset of the computing device's memory, for instance by determining the set of memory pages that have been accessed within a specified recent timeframe. The system then uses this active subset to produce an estimate of actively-used memory for the computing device. By producing an estimate of actively-used memory, which does not include inactive program memory and inactive memory speculatively-allocated for the operating system, the system facilitates determining the actual amount of additional memory available for programs on the computing device.

### BACKGROUND

1. Field of the Invention

The present invention relates to techniques for determining memory usage for computing devices. More specifically, the present invention relates to a method and an apparatus for determining memory usage when the operating system for a computing device speculatively allocates otherwise-unused memory in an attempt to improve performance.

2. Related Art

An operating system for a computing device manages memory usage over time to facilitate resource sharing and efficient system operation. This involves allocating memory as needed for programs as they are invoked and as they execute. However, when the memory demands of a program exceed the available memory for the computing device, program performance may decrease dramatically. Hence, system designers often track memory usage to ensure that computing devices are provisioned with sufficient memory to meet expected loads.

Often, tracking memory usage involves comparing an amount of presently unallocated memory with the total amount of memory available in the computing device. However, for an operating system that speculatively allocates otherwise-unused memory in an attempt to improve performance, such tracking techniques typically report that the computing device's memory is being completely utilized, regardless of the actual number, activity, and memory usage of programs running on the computing device. This over-reporting of memory usage can greatly complicate the process of memory provisioning.

Hence, what is needed is a system that facilitates determining memory usage for a computing device without the above-described problems.

### SUMMARY

One embodiment of the present invention provides a system that determines memory usage for a computing device. Within the computing device, an operating system manages memory allocation, and speculatively allocates otherwise-unused memory in an attempt to improve performance. During operation, the system receives a request to estimate the memory usage for the computing device. In response, the system determines an active subset of the computing device's memory, for instance by determining the set of memory pages that have been accessed within a specified recent timeframe. The system then uses this active subset to produce an estimate of actively-used memory for the computing device. By producing an estimate of actively-used memory, which does not include inactive program memory and inactive memory speculatively-allocated for the operating system, the system facilitates determining the actual amount of additional memory available for programs on the computing device.

In some embodiments, the operating system is the Linux™ operating system (Linux™ is a trademark of the Linux Mark Institute). Note that the operating system can include one of multiple implementations of Linux™ (e.g., Debian, SUSE Linux™, Red Hat, Ubuntu, etc.).

In some embodiments, the estimate of actively-used memory includes memory actively used by programs as well as memory actively used by the operating system for speculative and non-speculative purposes.

In some embodiments, the active subset of the memory includes actively-used memory and committed memory. Committed memory includes memory that has been allocated to programs by the operating system, but not yet actually read from or written to by the programs.

In some embodiments, the active subset of the memory is determined from a set of memory parameters and/or memory statistics produced by the operating system.

In some embodiments, accurately estimating active memory usage facilitates capacity planning and/or memory bottleneck diagnostics. For instance, the system can track active memory usage over time to determine whether the computing device has sufficient memory during operation for a given program load.

In some embodiments, the system determines the amount of free (e.g., inactive) memory by comparing the estimate with the total available system memory.

### BRIEF DESCRIPTION OF THE FIGURES

FIG. 1 illustrates a block diagram of a computer system in accordance with embodiments of the present invention.

FIG. 2 illustrates exemplary memory usage for a computing device in accordance with an embodiment of the present invention.

FIG. 3A illustrates an exemplary graph of memory usage collected over a time interval for a computing device in accordance with an embodiment of the present invention.

FIG. 3B illustrates an exemplary graph of memory usage collected over a time interval for a computing device with a speculative operating system in accordance with an embodiment of the present invention.

FIG. 4 presents a flow chart illustrating the process of determining memory usage for a computing device in accordance with an embodiment of the present invention.

Table 1 illustrates an exemplary /proc/meminfo file for a computing device running a Linux™ operating system in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system perform the methods and processes embodied as data structures and code and stored within the computer-readable storage medium.

Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

### Computing Device

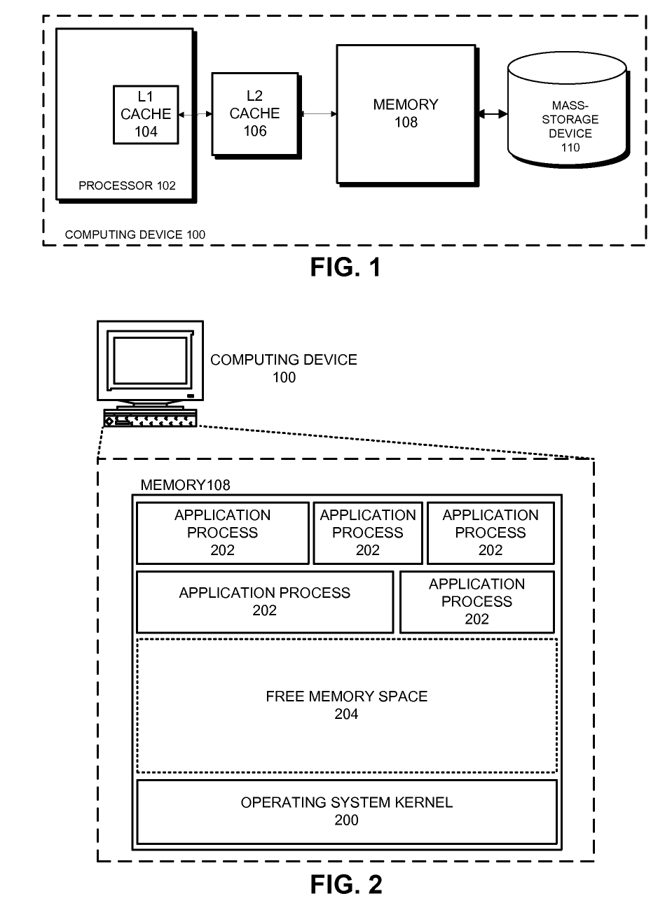

FIG. 1 presents a block diagram of a computing device 100 in accordance with embodiments of the present invention. Computing device 100 includes processor 102, L2 cache 106, memory 108, and mass-storage device 110.

Processor 102 is a general-purpose processor that performs computational operations. For example, processor 102 can be a central processing unit (CPU) such as a microprocessor. On the other hand, processor 102 can be a controller or an application-specific integrated circuit. Processor 102 may include L1 cache 104. (In some embodiments of the present invention, L2 cache 106 may also be included in processor 102, or no L1 or L2 caches are present at all.)

Mass-storage device 110, memory 108, L2 cache 106, and L1 cache 104 collectively form a memory hierarchy that stores data and instructions for processor 102. Generally, mass-storage device 110 is a high-capacity memory, such as a disk drive or a large flash memory, with a large access time, while L1 cache 104, L2 cache 106, and memory 108 are smaller, faster semiconductor memories that store copies of frequently used data. Memory 108 is typically a dynamic random access memory (DRAM) structure that is larger than L1 cache 104 and L2 cache 106, whereas L1 cache 104 and L2 cache 106 are typically comprised of smaller static random access memories (SRAM). In some embodiments, L2 cache 106, memory 108, and mass-storage device 110 are shared between one or more processors in computing device 100. Such memory structures are well-known in the art and are therefore not described in more detail.

Note that computing device 100 may incorporate techniques that can virtually extend the memory space of the device by using mass-storage device 110 as a “swap space” for memory 108. Such virtual memory techniques allow programs that are larger than the physical memory 108 to be run on computing device 100 by “swapping” inactive portions of the program out to the slower, larger mass-storage device 110 as needed. Note that while virtual memory techniques extend the computational capabilities of a device, the large difference in access speed between memory 108 and mass-storage device 110 makes it practical to use swap space on only a limited basis, such as when no space is left in memory 108.

Although we use specific components to describe computing device 100, in alternative embodiments different components can be present in computing device 100. For example, computing device 100 can include video cards, network cards, optical drives, and/or other peripheral devices that are coupled to processor 102 using a bus, a network, or another suitable communication channel. Alternatively, computing device 100 may include one or more additional processors, wherein the processors share some or all of L2 cache 106, memory 108, and mass-storage device 110.

Computing device 100 can be used in many different types of electronic devices. For example, computing device 100 can be part of a desktop computer, a laptop computer, a server, a media player, an appliance, a cellular phone, a piece of testing equipment, a network appliance, a calculator, a personal digital assistant (PDA), a hybrid device (i.e., a “smart phone”), a guidance system, a control system (e.g., an automotive control system), or another electronic device.

### Memory Management for Computing Devices

FIG. 2 illustrates exemplary memory usage for computing device 100. During operation, memory 108 of computing device 100 is shared between a number of different processes. For instance, an operating system kernel 200 that stays resident in memory 108 may allocate different regions of memory 108 to a range of application processes 202 in response to user and/or application requests. Operating system kernel 200 may also maintain and allocate additional memory space from a region of free memory space 204.

In one embodiment of the present invention, memory profiling techniques are used to determine how systems utilize resources. For instance, such techniques can be used to determine whether lack of memory is slowing down the performance of the computing device for a given load. Determining the performance of the memory hierarchy typically involves accurately measuring memory usage over time, for instance to determine: the total amount of memory that has been allocated to the operating system and/or application processes; the average resident size of the operating system; different quantities of memory allocated and accessed by different applications; and trends and cycles in application memory usage.

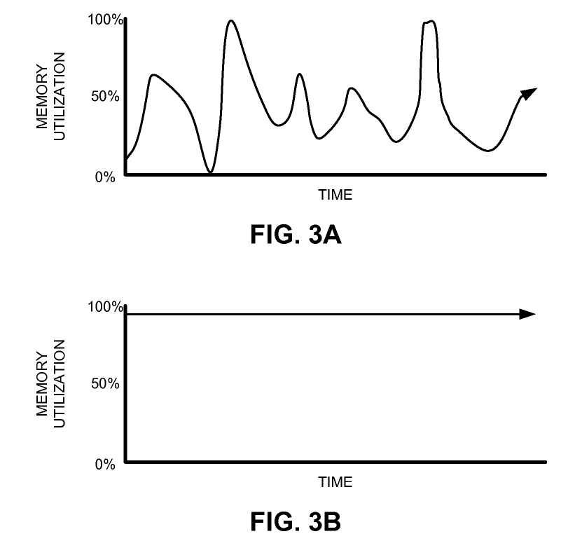

FIG. 3A illustrates an exemplary graph of memory usage collected over a time interval for a computing device. This exemplary graph illustrates the fluctuating memory usage for the computing device. When a user opens a new application, the percentage of memory used typically increases, and as applications are closed, the percentage of memory used typically decreases. Note that additional profiling data may also be collected. For instance, profiling efforts may also track the amount of swap space being used (e.g., when the memory load causes the operating system to swap inactive pages in memory out to a lower level in the memory hierarchy to make space for other purposes).

In some embodiments of the present invention, the operating system speculatively allocates free memory space during operation in an attempt to improve performance. For instance, the operating system may use available and otherwise-unused memory pages to improve performance until such pages are needed more urgently for another purpose (such as a user-invoked program). For example, the operating system may, based on predictions of spatial and temporal locality, use available memory to speculatively cache frequently-accessed files that are likely to be accessed again. Alternatively, the operating system may use available memory to maintain a variable-sized memory buffer that caches frequently-accessed memory pages that would otherwise be swapped out to another (slower) level of the memory hierarchy (e.g., using available space to cache frequently-accessed pages that would otherwise be swapped out to disk in a virtual memory system, and would then need to be re-loaded from the swap space before they could be used again).

Unfortunately, while such speculative operations can improve performance, they can also complicate memory profiling. For instance, in computing devices where host-monitoring solutions define and report a device memory utilization as the amount of physical memory allocated divided by the physical memory size, such speculative memory allocation can give the impression that memory size is creating a bottleneck. For instance, for many recent Linux™ operating system kernels that speculatively seek to make use of all available resources, a memory indicator based on such a memory utilization calculation always indicates that memory usage is at or above 95% (as illustrated in FIG. 3B). While some application loads may actually cause such utilizations, in many cases such a utilization graph only reflects the underlying speculative nature of the operating system, and is not useful for diagnosing memory bottlenecks or capacity planning. Many tools ported from previous programming environments and/or older operating systems report memory usage based on the amount of free memory, and as a result report memory utilizations that, while accurate, reflect the design of the operating system rather the actual memory usage of programs.

### Determining the Active Memory Usage for Computing Devices

One embodiment of the present invention calculates memory usage for a computing device by determining the active set of memory being used. For instance, the system can determine a memory utilization index (MUI) as a percentage:

MUI=(Active/Total Memory)*100%,

where “Total Memory” is the total amount of memory available in the computing device, and “Active” is an indicator for the actively-used pages of memory for the computing device.

Note that determining the actively-used subset of memory for a computing device may vary depending on the type, implementation, and/or organization of the operating system. For instance, the active memory set may include memory regions that have been accessed within a specified recent timeframe and memory that has been allocated (e.g., “committed”) to processes by the operating system, but not actually read or written by the receiving program yet (and hence not considered truly active by the operating system). Note that, when a memory profiling technique profiles with a coarse sampling rate, ignoring such committed memory may miss important pending operations and/or effects, and may consequently cause inaccurate memory usage estimates.

In one embodiment of the present invention, the active subset of memory for a computing device is determined from a set of memory parameters and/or memory statistics produced by the device's operating system. For instance, in some versions of the Linux™ operating system, a value for the active set of memory can be determined based on information extracted from the /proc/meminfo file.

Table 1 illustrates an exemplary /proc/meminfo file for a computing device running a Linux™ operating system. Note that the total memory active set of memory for the computing device associated with this exemplary file can be determined by accessing the MemTotal (total memory, ˜2 GB), Active (actively-used memory, ˜640 MB), and Committed_AS (committed, but unread/unwritten memory space, ˜162 MB) fields. In this example, the MUI is approximately 39% (e.g., ((162+640)/2000)*100).

Note that in some embodiments of the present invention, memory allocated by the operating system for speculative purposes is, if actively used, considered as active for purposes of computing the MUI. For instance, speculative memory regions used by the operating system for caching frequently-accessed files or to cache frequently-accessed memory pages may, if active (e.g., recently-used), be included in the set of memory pages for the device. Alternatively, some embodiments may not consider memory speculatively-allocated by the operating system as being active for purposes of computing the MUI.

TABLE 1

| | total: | used: | free: | shared: | buffers: | cached: |
|---|---|---|---|---|---|---|
| Mem: | 2104627200 | 2074615808 | 30011392 | 0 | 293613568 | 1399672832 |
| Swap: | 4293586944 | 0 | 4293586944 | | | |

| | | |
|---|---|---|
| MemTotal: | 2055300 | kB |
| MemFree: | 29308 | kB |
| MemShared: | 0 | kB |
| Buffers: | 286732 | kB |
| Cached: | 1366868 | kB |
| SwapCached: | 0 | kB |
| Active: | 640736 | kB |
| ActiveAnon: | 65800 | kB |
| ActiveCache: | 574936 | kB |
| Inact_dirty: | 827000 | kB |
| Inact_laundry: | 207720 | kB |
| Inact_clean: | 43052 | kB |
| Inact_target: | 343700 | kB |
| HighTotal: | 1179456 | kB |
| HighFree: | 12000 | kB |
| LowTotal: | 875844 | kB |
| LowFree: | 17308 | kB |
| SwapTotal: | 4192956 | kB |
| SwapFree: | 4192956 | kB |
| CommitLimit: | 5220604 | kB |
| Committed_AS: | 162380 | kB |
| HugePages_Total: | 0 | |
| HugePages_Free: | 0 | |
| Hugepagesize: | 2048 | kB |

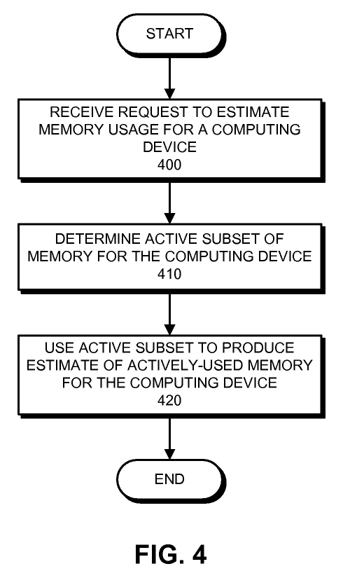

FIG. 4 presents a flow chart illustrating the process of determining memory usage for a computing device. During operation, the system receives a request to estimate the memory usage for the computing device (operation 400). In response to this request, the system determines an active subset of a memory for the computing device (operation 410). For instance, the system may determine a set of memory regions that have been accessed within a specified recent timeframe. The system then uses this active subset to produce an estimate of actively-used memory for the computing device (operation 420). By determining an estimate of actively-used memory that does not include inactive program memory and inactive memory speculatively-allocated for operating-system purposes, the described system facilitates determining an actual amount of additional memory available for programs on the computing device.

In some embodiments of the present invention, the system tracks active memory usage over time. For instance, the system may continuously compare the active memory usage to a set of alert thresholds. If the system detects an MUI that persists above an 80% threshold for over 30 seconds, the system may signal a yellow alert indicating potential memory-related performance issues. Similarly, if the system detects an MUI that persists above a 95% threshold for over 30 seconds, the system may signal a red alert indicating a very high likelihood of memory-related performance issues. Note that the system may need to adjust the described MUI formula and thresholds to match a given operating system and physical memory size. For instance, the described techniques may set reliable yellow and red thresholds for a range of Linux™ kernels with at least 1 G of RAM (random-access memory), but may need adjustments to determine an accurate memory utilization threshold for computing devices with memory sizes smaller than 256 M.

In summary, one embodiment of the present invention calculates memory usage for a computing device by determining the active set of memory in use. In doing so, the system provides an estimate of memory usage that is not misled by an operating system's speculative allocation of all available memory. Hence, the described system facilitates accurate capacity planning and/or memory bottleneck diagnostics, and thereby improves the return on income for computing infrastructure.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for determining memory usage for a computing device, wherein an operating system manages memory allocation for the computing device, where the operating system speculatively allocates otherwise-unused memory in an attempt to improve performance, comprising:
receiving a request to estimate memory usage for the computing device;
determining an active subset of a memory for the computing device, wherein the active subset comprises memory regions that have been accessed within a specified recent timeframe; and
using the active subset to produce an estimate of actively-used memory for the computing device;
wherein the estimate of actively-used memory does not include inactive program memory and inactive memory speculatively-allocated by the operating system, which facilitates determining an actual amount of additional memory available for programs on the computing device.

2. The method of claim 1, wherein the operating system is the Linux™ operating system.

3. The method of claim 2, wherein the estimate of actively-used memory includes memory actively used by programs as well as memory actively used by the operating system for speculative and non-speculative purposes.

4. The method of claim 3,
wherein the active subset of the memory includes actively-used memory and committed memory; and
wherein committed memory includes memory that has been allocated to programs by the operating system, but not yet actually read from or written to by the programs.

5. The method of claim 4, wherein the active subset of the memory is determined from a set of memory parameters and/or memory statistics produced by the operating system.

6. The method of claim 1,
wherein accurately estimating active memory usage facilitates capacity planning and/or memory bottleneck diagnostics; and
wherein the method further involves tracking active memory usage over time to determine whether the computing device has sufficient memory during operation.

7. The method of claim 1, wherein the method further involves determining the amount of free memory by comparing the estimate with the total available system memory.

8. A computer-readable storage medium storing instructions that when executed by a computer cause the computer to perform a method for determining memory usage for a computing device, wherein an operating system manages memory allocation for the computing device, where the operating system speculatively allocates otherwise-unused memory in an attempt to improve performance, the method comprising:
receiving a request to estimate memory usage for the computing device;
determining an active subset of a memory for the computing device, wherein the active subset comprises memory regions that have been accessed within a specified recent timeframe; and
using the active subset to produce an estimate of actively-used memory for the computing device;
wherein the estimate of actively-used memory does not include inactive program memory and inactive memory speculatively-allocated by the operating system, which facilitates determining an actual amount of additional memory available for programs on the computing device.

9. The computer-readable storage medium of claim 8, wherein the operating system is the Linux™ operating system.

10. The computer-readable storage medium of claim 9, wherein the estimate of actively-used memory includes memory actively used by programs as well as memory actively used by the operating system for speculative and non-speculative purposes.

11. The computer-readable storage medium of claim 10, wherein the active subset of the memory includes actively-used memory and committed memory; and
wherein committed memory includes memory that has been allocated to programs by the operating system, but not yet actually read from or written to by the programs.

12. The computer-readable storage medium of claim 11, wherein the active subset of the memory is determined from a set of memory parameters and/or memory statistics produced by the operating system.

13. The computer-readable storage medium of claim 8,
wherein accurately estimating active memory usage facilitates capacity planning and/or memory bottleneck diagnostics; and
wherein the method further involves tracking active memory usage over time to determine whether the computing device has sufficient memory during operation.

14. The computer-readable storage medium of claim 8, wherein the method further involves determining the amount of free memory by comparing the estimate with the total available system memory.

15. An apparatus that determines memory usage for a computing device, wherein an operating system manages memory allocation for the computing device, where the operating system speculatively allocates otherwise-unused memory in an attempt to improve performance, comprising:
a receiving mechanism configured to receive a request to estimate memory usage for the computing device;
a determining mechanism configured to determine an active subset of a memory for the computing device, wherein the active subset comprises memory regions that have been accessed within a specified recent timeframe; and
a producing mechanism configured to use the active subset to produce an estimate of actively-used memory for the computing device;
wherein the estimate of actively-used memory does not include inactive program memory and inactive memory speculatively-allocated by the operating system, which facilitates determining an actual amount of additional memory available for programs on the computing device.

16. The apparatus of claim 15, wherein the operating system is the Linux™ operating system.

17. The apparatus of claim 16, wherein the estimate of actively-used memory includes memory actively used by programs as well as memory actively used by the operating system for speculative and non-speculative purposes.

18. The apparatus of claim 17,
wherein the active subset of the memory includes actively-used memory and committed memory; and
wherein committed memory includes memory that has been allocated to programs by the operating system, but not yet actually read from or written to by the programs.

19. The apparatus of claim 15,
wherein accurately estimating active memory usage facilitates capacity planning and/or memory bottleneck diagnostics; and
wherein the determining mechanism is further configured to track active memory usage over time to determine whether the computing device has sufficient memory during operation.

20. The apparatus of claim 15, wherein the determining mechanism is further configured to determine the amount of free memory by comparing the estimate with the total available system memory.
